(19) United States
(12) Patent Application Publication
(10) Pub. No.: US 2025/0385478 A1
(43) Pub. Date: Dec. 18, 2025

(54) Safety Guard for a Crimping Device

(71) Applicant: ABB Schweiz AG, Baden (CH)

(72) Inventor: Jared M. Davis, Tarboro, NC (US)

(73) Assignee: ABB Schweiz AG, Baden (CH)

(21) Appl. No.: 18/741,184

(22) Filed: Jun. 12, 2024

(51) Int. Cl. H01R 43/042

(52) U.S. Cl. CPC H01R 43/042

(57) ABSTRACT

A safety guard for a crimping device includes: a primary bumper having: a primary bumper leading face, and a first primary bumper leg and a second primary bumper leg, each extending from the primary bumper leading face in a longitudinal direction; a secondary bumper having: a secondary bumper leading face, and a first secondary bumper leg and a second secondary bumper leg, each extending from the secondary bumper leading face in the longitudinal direction; a first attachment base connecting the first primary bumper leg to the first secondary bumper leg; and a second attachment base connecting the second primary bumper leg to the second secondary bumper leg. The primary bumper and the secondary bumper are spaced apart from one another in a latitudinal direction so as to create a receiving gap between the primary bumper and the secondary bumper.

### FIELD

The present application generally relates to safety guards for battery-operated wire-crimping devices.

### BACKGROUND

A manually-operated wire-crimping device can be used to attach a crimp terminal to a stripped end of a wire so as to facilitate connecting the wire to, for example, a terminal vis-à-vis the crimp terminal. To accomplish this, however, it is necessary for the user of the manually-operated wire-crimping device to exert a significant amount of force on the handles of the crimping device.

In order to minimize the amount of force exerted by the operator, however, there are also power-assisted wire-crimping devices, such as the crimping device 2 shown in FIG. 1. Such a crimping device 2 generally includes a handle 4 for gripping by the user, with the handle 4 being situated between a crimping end 6 and a non-crimping end 8 of the crimping device 2. The crimping device 2 extends in a longitudinal direction λ, which is the direction of the longest dimension of the crimping device 2, which in the crimping device 2 shown is generally from the crimping end 6 to the non-crimping 8 end. At the crimping end 6, the crimping device 2 includes crimping jaws 10, 12. Each crimping jaw 10, 12 can comprise two components spaced apart from one another. For example, the crimping device 2 can include first crimping jaw 10A, 10B and second crimping jaw 12A, 12B. The first crimping jaw 10A, 10B holds a first crimping die 14, and opposite thereof the second crimping jaw 12A, 12B holds a second crimping die 16. In the example shown, the second crimping die 16 comprises a plurality of crimping ridges 18A, 18B, 18C, while the first crimping comprises a plurality of corresponding receiving guides 20A, 20B, 20C, or vice versa. Each crimping ridge/receiving guide set (e.g., crimping ridge 18A and receiving guide 20A, crimping ridge 18B and receiving guide 20B, etc.) is sized differently so as to accommodate different gauge wires. For example, if the wire to be crimped has a larger gauge, the operator would insert the wire into crimping ridge 18C and receiving guide 20C. If the wire to be crimped has a smaller gauge, the operator would insert the wire into, for example, crimping ridge 18A and receiving guide 20A.

The crimping device 2 also includes a trigger 22 that can be used to execute a crimping operation once the stripped end of the wire and associated crimp terminal are arranged within the desired receiving guide 20. More particularly, the wire/crimp terminal joint is disposed in the receiving guide 20, the operator of the crimping device 2 presses the trigger 22 which causes the first crimping jaw 10 and the second crimping jaw 12 to come together from a non-crimping position (as shown in FIG. 1) into a crimping position. In the crimping position, the corresponding crimping ridge 18 compresses the wire/crimp terminal joint against the receiving guide, affixing the crimp terminal to the stripped end of the wire. Once the first crimping jaw 10 and the second crimping jaw 12 return to the non-crimping position, the wire, with the crimp terminal now attached thereto, can be withdrawn from the crimping device 2.

To carry out the power-assisted crimping operation, the crimping device 2 may include a batter 24, which may be disposed at the non-crimping end 8 of the crimping device 2. Additionally, the crimping device can include one or more anchor points 26, which may, for example, house screws that hold the two halves of the crimping device 2 together. The anchor points 26 may be arranged, for example, on the crimping end 6 of the crimping device 2. FIG. 1 shows anchor points 26A, 26B on the crimping device 2, but due to general symmetry, similarly arranged anchor points 26C, 26D appear on the other side of crimping device 2. Anchor points 26A, 26B, 26C, 26D can all be the same shape.

Due to the movement of the first crimping jaw 10 and the second crimping jaw 12 from the non-crimping position to the crimping position, the crimping device 2 has exposed pinch points. As such, an operator of the crimping device 2 can be easily injured (e.g., by having a finger pinched, cut, or broken) while attempting to affix a crimp terminal to a wire (e.g., due to unintentional contact with the pinch points). The risk for injury only increases when the crimping device 2 is power-assisted, as the first crimping jaw 10 and the second crimping jaw 12 come together with a much stronger clamping force as compared to a non-power-assisted clamping device.

There is therefore a need to minimize the risk of injury when using a crimping device, such as the crimping device 2 of FIG. 1.

### SUMMARY

In an embodiment, the present invention provides a safety guard for a crimping device, comprising: a primary bumper, comprising: a primary bumper leading face, and a first primary bumper leg and a second primary bumper leg, each extending from the primary bumper leading face in a longitudinal direction; a secondary bumper, comprising: a secondary bumper leading face, and a first secondary bumper leg and a second secondary bumper leg, each extending from the secondary bumper leading face in the longitudinal direction; a first attachment base connecting the first primary bumper leg to the first secondary bumper leg; and a second attachment base connecting the second primary bumper leg to the second secondary bumper leg, wherein the primary bumper and the secondary bumper are spaced apart from one another in a latitudinal direction so as to create a receiving gap between the primary bumper and the secondary bumper.

In an embodiment, the present invention provides a method of attaching a safety guard to a crimping device, the method comprising: providing the crimping device, the crimping device comprising a first crimping jaw, a second crimping jaw, and at least one anchor point; providing the safety guard, the safety guard comprising at least one fastening point. a primary bumper, and a secondary bumper, the primary bumper and the secondary bumper extending in a longitudinal direction and being spaced apart from one another in a latitudinal direction so as to create a receiving gap therebetween; affixing the at least one fastening point to the at least one anchor point so that the primary bumper at least partially surrounds the first crimping jaw and the secondary bumper at least partially surrounds the second crimping jaw.

### BRIEF DESCRIPTION OF THE DRAWINGS

FIG. 1 shows a crimping device according to the prior art in a perspective view;

FIG. 2 shows a safety guard according to the present disclosure in a perspective view;

FIG. 3 shows the safety guard of FIG. 2 in a top view;

FIG. 4 shows the safety guard of FIG. 2 in a front view;

FIG. 5 shows the safety guard of FIG. 2 in a side view;

FIG. 6 shows a detail view of the safety guard of FIG. 5;

FIG. 7 shows a sectional view of the safety guard of FIG. 5;

FIG. 8 shows the safety guard of FIG. 2 attached to the crimping device of FIG. 1 in a front view, with the crimping dies of the crimping device in a crimping position;

FIG. 9 shows the safety guard of FIG. 2 attached to the crimping device of FIG. 1 in a perspective view, with the crimping dies of the crimping device in a non-crimping position;

FIG. 10 shows a side perspective view of the safety guard and crimping device of FIG. 8, with the crimping dies of the crimping device in a non-crimping position;

FIG. 11 shows a top perspective view of the safety guard and crimping device of FIG. 8, with the crimping dies of the crimping device in a non-crimping position; and

FIG. 12 shows a front view of the safety guard and crimping device of FIG. 8, with the crimping dies of the crimping device in a crimping position.

### DETAILED DESCRIPTION

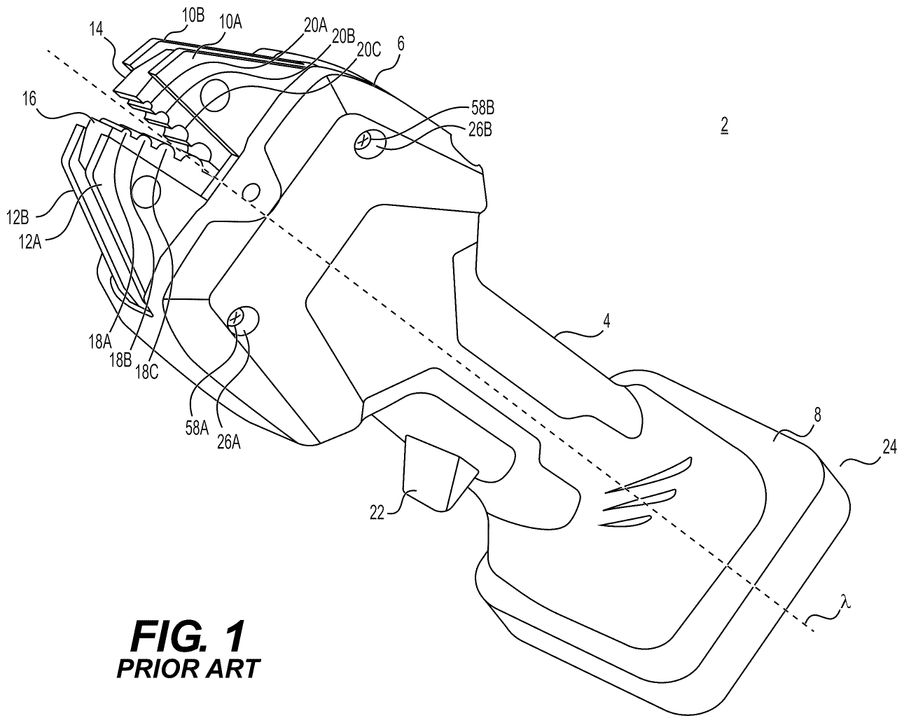

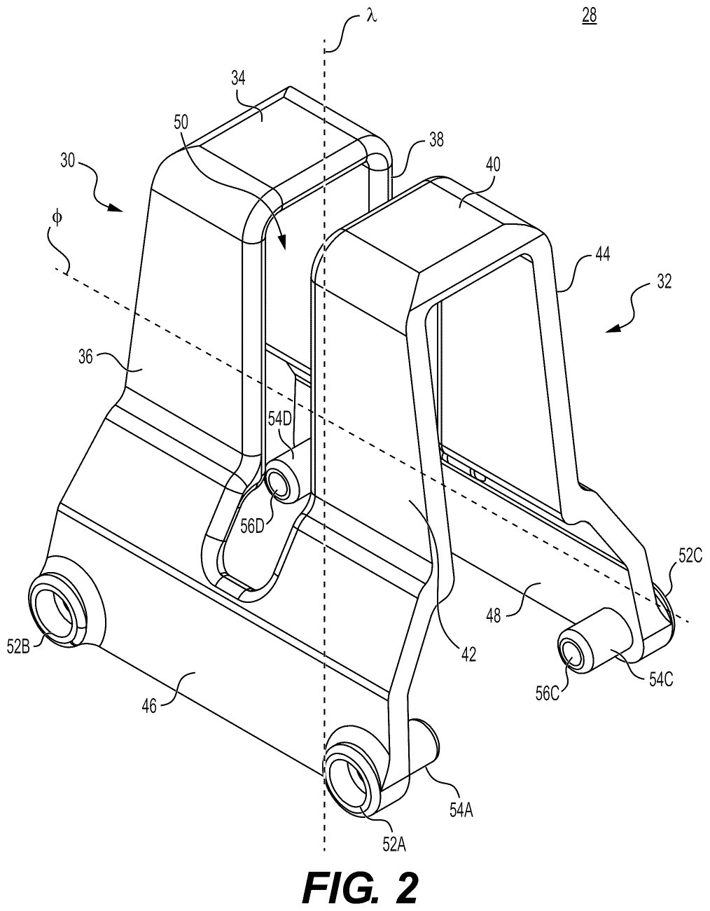

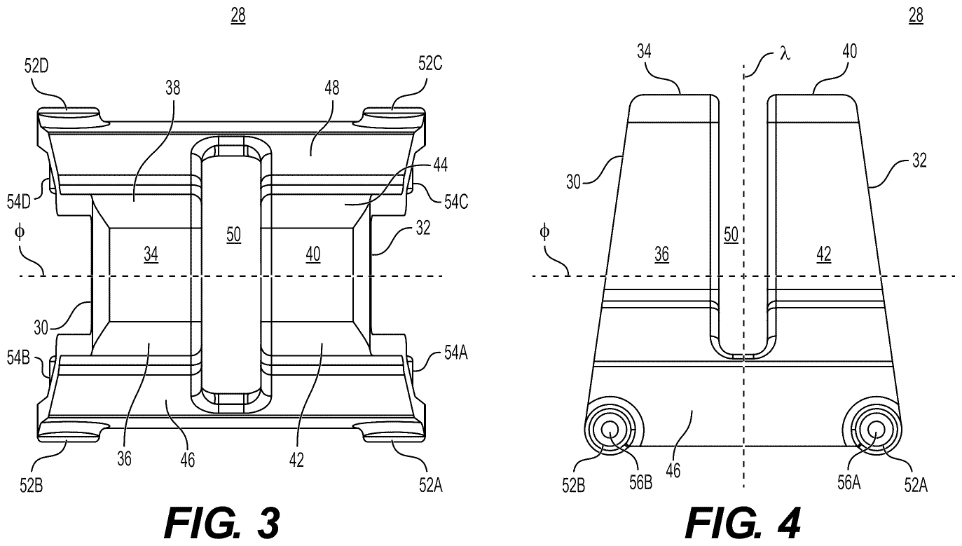

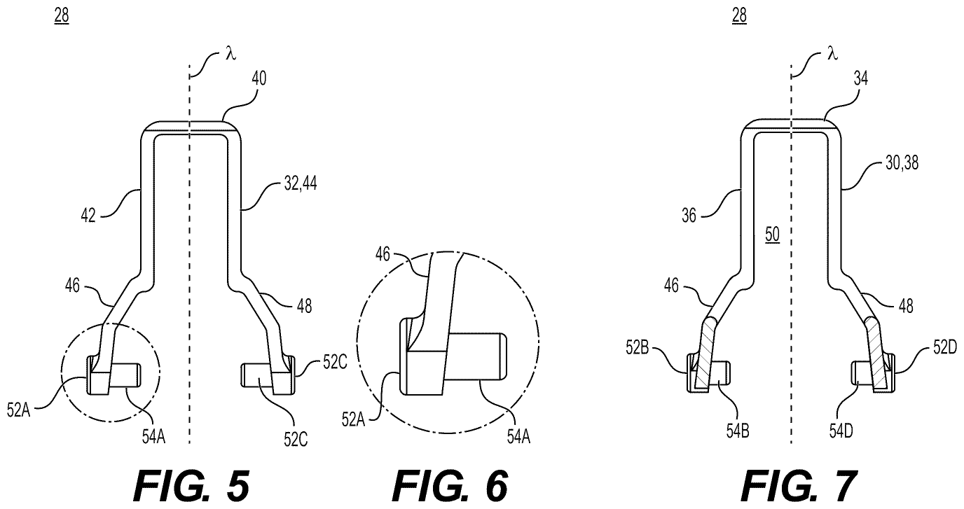

To minimize injury risk, the present application describes various embodiments of a safety guard 28, several views of which are shown in FIGS. 2-7. In general, the safety guard 28 is attachable to a crimping device, such as crimping device 2 in FIG. 1, so as to prevent unintentional contact with the crimping jaws 10, 12 and crimping dies 14, 16 of the crimping device 2, helping avoid accidents and injuries, all while maintaining the full functionality of the crimping device 2 and its intended use. Moreover, using the safety guard 28 avoids the need to replace an existing crimping device 2, which is expensive, with another suitable tool.

The safety guard 28 can be attached to the crimping device 2 in a snap-on configuration or a screw-on configuration, as will be discussed in more detail herein. The snap-on configuration can be used when the crimping dies 14, 16 are likely to be changed regularly. For example, if different gauge wires or different size crimp are needed, a snap-on configuration allows the safety guard 28 to be easily removed from the crimping device 2, and reattached after the crimping dies 14, 16 are replaced. When the crimping dies 14, 16 do not need to be changed as regularly, it may be more desirable to use a screw-on configuration of the safety guard 28.

As shown in FIGS. 2-7, the safety guard 28 can include a primary bumper 30 and a secondary bumper 32. The primary bumper 30 can have a primary bumper leading face 34, a first primary bumper leg 36, and a second primary bumper leg 38. Both the first primary bumper leg 36 and the second primary bumper leg 38 can extend from the primary bumper leading face 34 in a longitudinal direction λ, which like the longitudinal direction λ described in connection with FIG. 1, generally extends along the longest dimension of the safety guard 28. In this regard the longitudinal direction λ in FIG. 1 and the longitudinal direction λ in the remaining figures can be considered the same. A latitudinal direction ϕ is defined as a direction generally perpendicular to the longitudinal direction λ. In this manner, when the safety guard 28 is attached to the crimping device 2, the primary bumper 30 at least partially surrounds one crimping jaw 10 (e.g., first crimping jaw 10A) so as to create a protective barrier around the crimping jaw 10.

The secondary bumper 32 can be of a generally similar shape as that of the primary bumper 30. For example, the secondary bumper 32 can include a secondary bumper leading face 40, a first secondary bumper leg 42, and a second secondary bumper leg 44. Both the first secondary bumper leg 42 and the second secondary bumper leg 44 can extend from the secondary bumper leading face 40 in the longitudinal direction λ. In this manner, when the safety guard 28 is attached to the crimping device 2, the secondary bumper 32 at least partially surrounds one crimping jaw 10 (e.g., second crimping jaw 10B) so as to create a protective barrier around the crimping jaw 10.

The safety guard 28 can include a first attachment base 46 connecting the first primary bumper leg 36 to the first secondary bumper leg 42. The safety guard 28 can also include a second attachment base 48 connecting the second primary bumper leg 38 to the second secondary bumper leg 44.

The primary bumper 30 and the secondary bumper 32 are spaced apart from one another in the latitudinal direction ϕ so as to create a receiving gap 50 between the primary bumper 30 and the secondary bumper 32. The existence of the receiving gap 50 allows the crimping device 2 to still function as normal when the safety guard 28 is attached to the crimping device 2. Specifically, neither the primary bumper 30 nor the second bumper 32 interferes with the ability to place a wire and/or a crimp terminal between the crimping jaws 10, 12 of the crimping device 2.

The distance between the first primary bumper leg 36 and the second primary bumper leg 38 may be smaller than the distance between the first attachment base 46 and the second attachment base 48 in order to accommodate a crimping device 2 that increase in size from a tip of the crimping jaws 10, 12 in a direction of the crimping end 6.

In an embodiment, the primary bumper leading face 34 is generally co-planar with the secondary bumper leading face 40. In an embodiment, the first primary bumper leg 36 and the second primary bumper leg 38 are generally parallel to one another, while the first secondary bumper leg 42 and the second secondary bumper leg 44 are generally parallel to one another. In this manner, the safety guard is generally symmetric with respect to the longitudinal direction λ.

In an embodiment, the first primary bumper leg 36 and the first secondary bumper leg 42 are generally co-planar. Moreover, the second primary bumper leg 38 and the second secondary bumper leg 44 are generally co-planar.

In embodiment, the safety guard 28 includes one or more fastening points 52 that facilitate attachment of the safety guard 28 to the crimping device 2. At least one fastening point (e.g., fastening point 52A) is disposed on at least one of the first attachment base 46 and the second attachment base 48. FIGS. 2-7 show fastening point 52A being disposed on the first attachment base 46.

In embodiment, one or more fastening points 52 can include their own protrusions 54. For example, FIG. 2 shows that fastening point 52A includes protrusion 54A, while fastening point 52C includes protrusion 54C. A protrusion 54 disposed on one attachment base (e.g., protrusion 54A disposed on first attachment base 46) can extend toward the other attachment base (e.g., toward second attachment base 48). In this manner, the protrusions 54 of the fastening points 52 can be inserted into corresponding anchor points 26 on the crimping device 2 in order to attach the safety guard 28 to the crimping device 2. Specifically, the protrusions 54 allow the safety guard 28 to be attached to the anchor points 26 of the crimping device 2 with a tolerance fit. Such an arrangement may be referred to as a snap-on configuration, as discussed herein. FIGS. 2-7 show an embodiment of the safety guard 28 having two fastening points 52A, 52B disposed on the first attachment base 46 and two fastening points 52C, 52D disposed on the second attachment base 48. Protrusions 54A, 54B of fastening points 52A, 52B, respectively, extend from the first attachment base 46 toward the second attachment base 48. Conversely, protrusions 54C, 54D of fastening points 52C, 52D, respectively, extend from the second attachment base 48 toward the first attachment base 46.

In an embodiment, a fastening point 52 can include a through hole 56. The through hole 56 allows a fastener 58 to be inserted through the corresponding fastening point 52 and screwed into an anchor point 26 on the crimping device 2 in order to attach the safety guard 28 to the crimping device. Such an arrangement may be referred to as a screw-on configuration, as discussed herein. Use of a screw-on configuration does not preclude use of a screw-on configuration. Specifically, it possible for a fastening point 52 to have both a protrusion 54 and a through hole 56, and for the protrusion 54 to assist with the screw-on configuration (e.g., by helping to align the fastener 58 passing through the through hole 56 with a corresponding anchor point 26 on the crimping device 2).

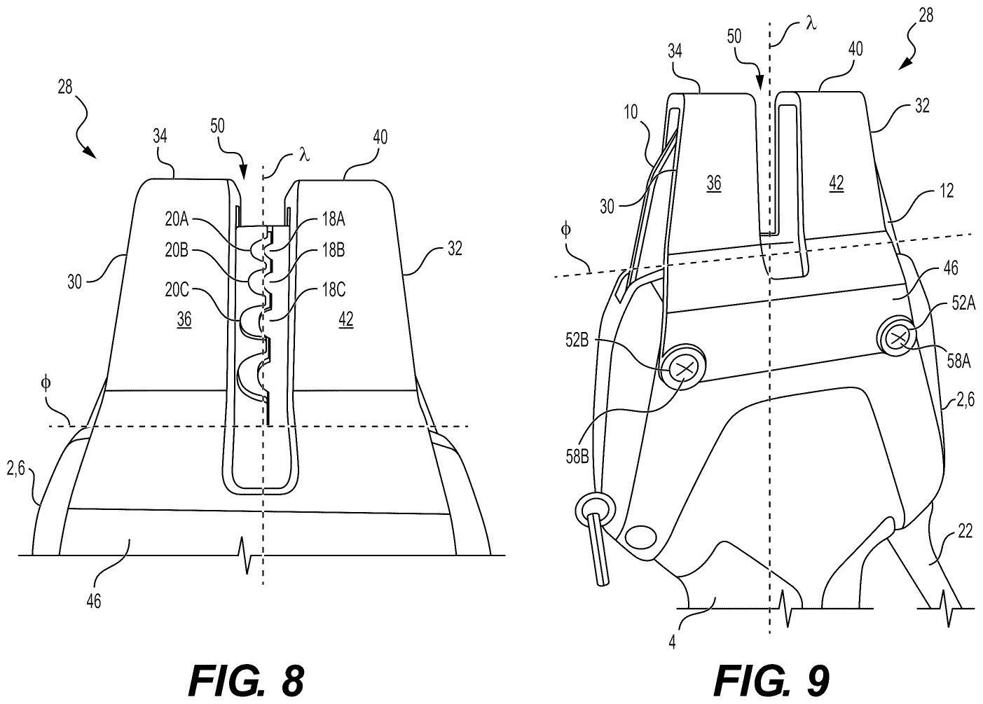

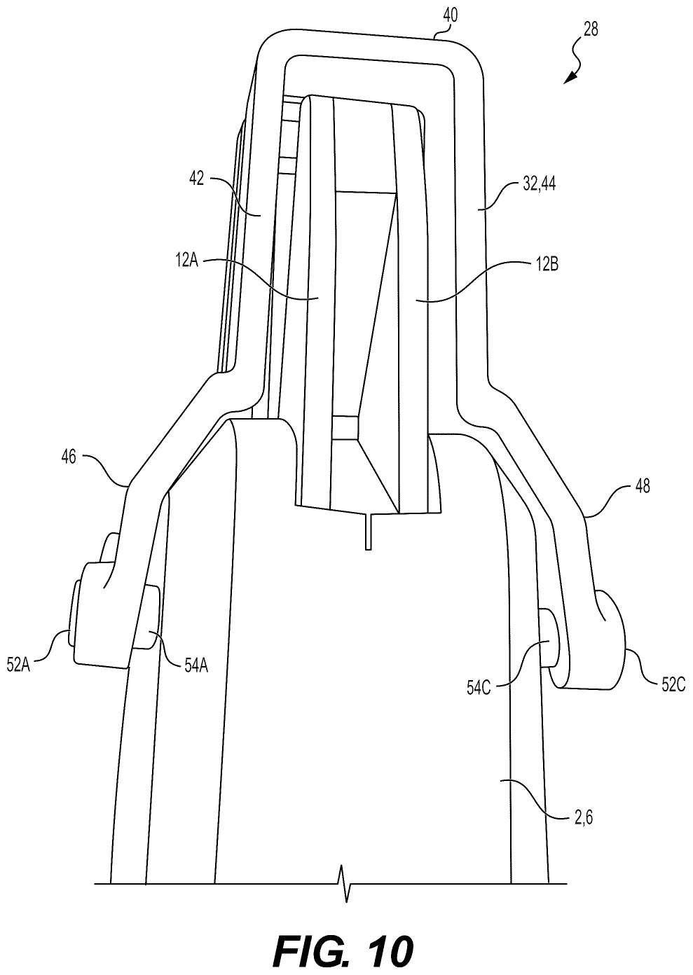

FIGS. 8-12 show the safety guard 28 attached to the crimping device by either the snap-on configuration or the screw-on configuration.

The present application also contemplates a method for attaching a safety guard 28 to a crimping device 2. The method can include providing a crimping device 2 as described herein. For example, the crimping device 2 can include a first crimping jaw 10, a second crimping jaw 12, and at least one anchor point 26. The method can also include providing a safety guard 28 as described herein. For example, the safety guard 28 can include at least one fastening point 52, a primary bumper 30, and a secondary bumper 32. The primary bumper 30 and the secondary bumper 32 can extend in a longitudinal direction λ (e.g., of the safety guard 28 and/or of the crimping device 2) and be spaced apart from one another in a latitudinal direction ϕ, the latitudinal direction ϕ being generally perpendicular to the longitudinal direction λ, so as to create a receiving gap 50 between the primary bumper 30 and the secondary bumper 32.

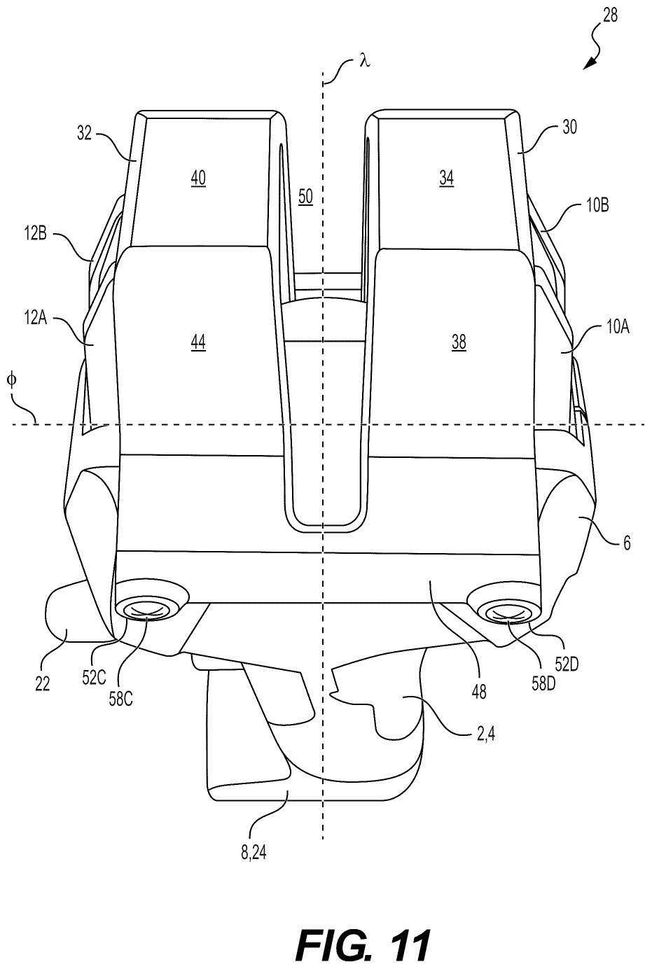

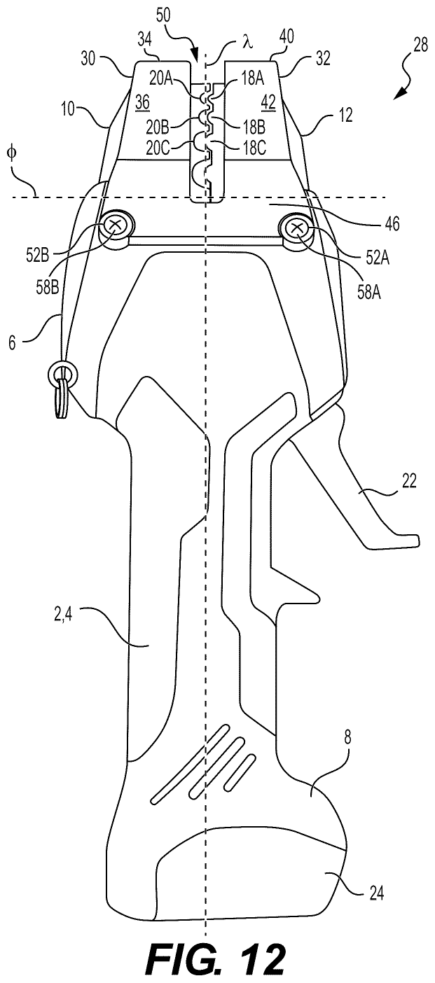

The method also includes affixing at least one fastening point 52 of the safety guard 28 to at least one anchor point 26 of the crimping device 2 so that the primary bumper 30 at least partially surrounds the first crimping jaw 10 and the secondary bumper 32 at least partially surrounds the second crimping jaw 12. Partially surrounding in this sense means that the arrangement of the primary bumper 30 and the secondary bumper 32 with respect to the first crimping jaw 10 and the second crimping jaw 12 limits the ability of a user of a crimping device 2 with the safety guard 28 attached thereto to insert a finger of the user into the receiving gap 50, effectively lowering the risk of the user's finger getting caught between first crimping jaw 10 and the second crimping jaw 12 during a crimping operation (i.e., when the first crimping jaw 10 and the second crimping jaw 12 move from a non-crimping position, as shown in FIG. 11, to a crimping position, as shown in FIG. 12).

In an embodiment, the fastening point 52 includes a protrusion 54, and affixing the fastening point 52 to the anchor point 26 includes inserting the protrusion 54 into the anchor point 26. Using one or more protrusions 54 allows the safety guard 28 to be attached to the anchor points 26 of the crimping device 2 with a tolerance fit. Such an arrangement may be referred to as a snap-on configuration, as discussed herein.

In an embodiment, the fastening point 52 has a through hole 56, and affixing the fastening point 52 to the anchor point 26 includes inserting a fastener 58 through the through hole 56 and into the anchor point 26. The fastener 58 can then be tightened (e.g., screwed), securing the safety guard 28 more tightly to the crimping device 2.

Other embodiments of a method for attaching the safety guard 28 to the crimping device 2 are also contemplated and within the scope of the present application.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

2 crimping device
4 handle
6 crimping end
8 non-crimping end
10, 10A, 10B first crimping jaw
12, 12A, 12B second crimping jaw
14 first crimping die
16 second crimping die
18, 18A, 18B, 18C crimping ridges
20, 20A, 20B, 20C receiving guides
22 trigger
24 battery
26, 26A, 26B, 26C, 26D anchor points
28 safety guard
30 primary bumper
32 secondary bumper
34 primary bumper leading face
36 first primary bumper leg
38 second primary bumper leg
40 secondary bumper leading face
42 first secondary bumper leg
44 second secondary bumper leg
46 first attachment base
48 second attachment base
50 receiving gap
52, 52A, 52B, 52C, 52D fastening points
54, 54A, 54B, 54C, 54D protrusions
56, 56A, 56B, 56C, 56D through holes
58, 58A, 58B, 58C, 58D fasteners
λ longitudinal direction
ϕ latitudinal direction

What is claimed is:

1. A safety guard for a crimping device, comprising:
a primary bumper, comprising:
a primary bumper leading face, and
a first primary bumper leg and a second primary bumper leg, each extending from the primary bumper leading face in a longitudinal direction;
a secondary bumper, comprising:
a secondary bumper leading face, and
a first secondary bumper leg and a second secondary bumper leg, each extending from the secondary bumper leading face in the longitudinal direction;
a first attachment base connecting the first primary bumper leg to the first secondary bumper leg; and
a second attachment base connecting the second primary bumper leg to the second secondary bumper leg,
wherein the primary bumper and the secondary bumper are spaced apart from one another in a latitudinal direction so as to create a receiving gap between the primary bumper and the secondary bumper.

2. The safety guard of claim 1, wherein the primary bumper leading face is generally co-planar with the secondary bumper leading face.

3. The safety guard of claim 1, wherein the first primary bumper leg and the second primary bumper leg are generally parallel to one another, and
wherein the first secondary bumper leg and the second secondary bumper leg are generally parallel to one another.

4. The safety guard of claim 1, wherein the first primary bumper leg and the first secondary bumper leg are generally co-planar.

5. The safety guard of claim 4, wherein the second primary bumper leg and the second secondary bumper leg are generally co-planar.

6. The safety guard of claim 1, further comprising:
at least one fastening point configured to attach the safety guard to the crimping device.

7. The safety guard of claim 6, wherein the at least one fastening point is disposed on at least one of the first attachment base and the second attachment base.

8. The safety guard of claim 7, wherein the at least one fastening point is disposed on the first attachment base, and
wherein the at least one fastening point comprises at least one protrusion that extends toward the second attachment base.

9. The safety guard of claim 6, wherein the at least one fastening point comprises two fastening points disposed on the first attachment base and two fastening points disposed on the second attachment base.

10. The safety guard of claim 9, wherein each fastening point disposed on the first attachment base comprises a protrusion that extends toward the second attachment base, and
wherein each fastening point disposed on the second attachment base comprises a protrusion that extends toward the first attachment base.

11. The safety guard of claim 6, wherein each fastening point of the at least one fastening point comprises a through hole.

12. A method of attaching a safety guard to a crimping device, the method comprising:
providing the crimping device, the crimping device comprising a first crimping jaw, a second crimping jaw, and at least one anchor point;
providing the safety guard, the safety guard comprising at least one fastening point, a primary bumper, and a secondary bumper, the primary bumper and the secondary bumper extending in a longitudinal direction and being spaced apart from one another in a latitudinal direction so as to create a receiving gap therebetween;
affixing the at least one fastening point to the at least one anchor point so that the primary bumper at least partially surrounds the first crimping jaw and the secondary bumper at least partially surrounds the second crimping jaw.

13. The method of claim 12, wherein the at least one fastening point has a least one protrusion, and
wherein affixing the at least one fastening point to the at least one anchor point comprises inserting the at least one protrusion into the at least one anchor point.

14. The method of claim 12, wherein the at least one fastening point has at least one through hole, and
wherein affixing the at least one fastening point to the at least one anchor point comprises inserting at least one fastener through the at least one through hole and into the at least one anchor point.

15. The method of claim 12, wherein the primary bumper comprises a primary bumper leading face,
wherein the secondary bumper comprises a secondary bumper leading face, and
wherein the primary bumper leading face is generally co-planar with the secondary bumper leading face.

16. The method of claim 12, wherein the primary bumper is generally parallel to the first crimping jaw, and
wherein the secondary bumper is generally parallel to the second crimping jaw.

17. The method of claim 12, wherein the primary bumper comprises a first primary bumper leg and a second primary bumper leg, each extending in the longitudinal direction, and
wherein the secondary bumper comprises a first secondary bumper leg and a second secondary bumper leg, each extending in the longitudinal direction.

18. The method of claim 17, wherein the first primary bumper leg and the second primary bumper leg are generally parallel to the first crimping jaw, and
wherein the first secondary bumper leg and the second secondary bumper leg are generally parallel to the second crimping jaw.

19. The method of claim 18, wherein the primary bumper comprises a primary bumper leading face connecting the first primary bumper leg and the second primary bumper leg, and
wherein the secondary bumper comprises a secondary bumper leading face connecting the first secondary bumper leg and the second secondary bumper leg.

20. The method of claim 19. wherein the primary bumper leading face is generally co-planar with the secondary bumper leading face.
